(19) United States
(12) Patent Application Publication
(10) Pub. No.: US 2026/0065275 A1
(43) Pub. Date: Mar. 5, 2026

(54) Fuzzy Correspondence Matching System

(71) Applicant: Capital One Services, LLC, McLean, VA (US)

(72) Inventors: Oleg Mikheev, Brooklyn, NY (US); John Li, Brooklyn, NY (US); Raj Gaurav, Hillsborough, NJ (US)

(21) Appl. No.: 18/823,069

(22) Filed: Sep. 3, 2024

(51) Int. Cl. G06Q 20/40; G06N 3/043; G06Q 20/02; G06Q 20/10; G06V 30/14

(52) U.S. Cl. CPC G06Q 20/4014; G06N 3/043; G06Q 20/02; G06Q 20/102; G06V 30/14

(57) ABSTRACT

Systems, methods, and apparatuses are described for automatically processing images of printed documents transmitted by third parties to identify associations between those printed documents and database entries. A computing device may store, in a database, records of various individuals. Those records may correspond to different individuals and may comprise one or more expected properties of a document o be received concerning a given individual. The computing device may later receive a document image and process it using Optical Character Recognition to identify textual content. A fuzzy matching algorithm may be used to corelate the textual content with the database records to identify a first record associated with an e-mail account. Based on a trust level associated with that e-mail account, funds may be transmitted.

### FIELD OF USE

Aspects of the disclosure relate generally to correlating disparate data in computing devices. More particularly, aspects described herein describe a process for processing images of printed documents transmitted by third parties to identify associations between those printed documents and database entries.

### BACKGROUND

It is increasingly common that documents generated by third parties, such as governmental entities, need to be correlated with database entries containing somewhat different data. For example, in the context of unclaimed property (e.g., where banks find sums of currency due to customers but where those banks cannot locate those customers), governmental entities (e.g., state registries) might purport to inform customers of their lost property, but may do so in inconsistent and unreliable ways (e.g., by sending form letters with inaccuracies, misspellings, general/vague characterizations of the property, or the like). This can cause banks a large issue: even if the correct customer might have been notified, it might be difficult to actually locate relevant customer entries in bank databases, especially where those customer entries contain wildly different information (e.g., different name spellings, slightly different currency amounts) than those contained in the governmental letter received by the customer.

One issue complicating the above problem is that, in general, third parties cannot be reliably convinced to use case numbers, docket numbers, or similar unique identifiers of customer claims. For example, while a bank might maintain its own unique identifiers for unclaimed properly in a database (e.g., “ID 3041” for $50 owed to Joe Smith as an unclaimed insurance payout), third parties such as governmental entities generally do not and will not reliably use those identifiers in their own correspondence to those customers. In fact, as already suggested above, it is often very common for governmental entities to misspell (or entirely omit) customer names, misspell (or entirely omit) customer addresses, use broad ranges when describing currency amounts, or the like. As a result, when a customer notified by such a letter provides a copy of (e.g., an image of) such a letter to the bank, the letter image is rarely sufficient, standing alone, to identify a single record of unclaimed property. Indeed, it is often the case that the letter is so generic and/or inaccurate that a human operator must manually evaluate the letter and, where possible, manually search through potentially relevant records to identify the correct database entry.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to automatically processing images of printed documents transmitted by third parties to identify associations between those printed documents and database entries. Prior to informing third parties (e.g., governmental entities) of information (e.g., unclaimed property), a computing device may store records for a plurality of different individuals. Each record might indicate expected properties of a document that might be provided to those individuals by the third party. For instance, for unclaimed property of $25.99, it might be known that the governmental entity will, in a letter, refer to this value as “Somewhere between $25 and $50,” and that broader description of the property might be stored as an entry in the database as associated with the customer. Then, some time later, the computing device might receive a document image of a document actually received by an individual. That image might be, for example, a picture of a document informing a user of their unclaimed property. That image may be then be processed using Optical Character Recognition (OCR) (and, for instance, an OCR algorithm) to identify textual content. The textual content may be filtered and/or otherwise processed to identify content of note, such as currency values, names, addresses, and the like. That textual content might then be compared to entries in the database using a fuzzy matching algorithm to identify a record. In this manner, the comparison is not exclusively between the textual content of the letter and the identification information of the individual (as, after all, the textual content might be wrong, broad, or the like)-rather, the comparison may be between the textual content of the document image and a record indicating a prediction of what the document will contain. In turn, this comparison (especially when a fuzzy matching algorithm is used) is significantly more likely to identify the correct record. Once a record is identified, an e-mail account associated with the record may be identified, and—if a level of trust associated with the e-mail account satisfies a threshold and based on determining that the record corresponds to the document image-then an electronic transmission of funds may be automatically generated.

More particularly, a computing device may store, in a database, a plurality of different records, wherein each record of the plurality of different records corresponds to a different individual and comprises one or more expected properties of a document to be received concerning the different individual. The computing device may receive, from a second computing device and via an e-mail account, a document image. The computing device may process, using an Optical Character Recognition (OCR) algorithm, the document image to identify textual content that comprises one or more of a quantity of currency, a date when a governmental entity transmitted a document corresponding to the document image, and/or a type of property. The computing device may then query, using a fuzzy matching algorithm and based on comparing at least a portion of the textual content to the one or more expected properties, the plurality of different records stored in the database to identify a first record of the plurality of different records. That first record may correspond to a first individual. Then, based on determining that a trust level associated with the e-mail account satisfies a threshold and based on determining that the first record corresponds to the document image, the computing device may automatically generate an electronic transmission of funds to an account associated with the first individual. Such a trust level might be determined based on a domain of the e-mail account, such that, as part of the preceding step, the computing device may determine the trust level associated with the e-mail account based on a domain of the e-mail account.

The process described herein may be related to a telephone call, and the automatic generation of the electronic transmission of funds may be conditioned on the trustworthiness of that telephone call. For example, the computing device may identify a record of a telephone call associated with the first record. In turn, the computing device may automatically generate the electronic transmission of funds based on a second trust level associated with the telephone call.

Given the use of the aforementioned fuzzy matching algorithm, the computing device may identify a record even when the value(s) in the record do not exactly match. For example, the first record may indicate a different quantity of currency, and the computing device may nonetheless identify the first record by determining that a difference between the quantity of currency and the different quantity of currency satisfies a threshold. As another example, the first record may indicate a different date when the governmental entity transmitted the document corresponding to the document image, and the computing device may nonetheless identify the first record by determining that a difference between the date and the different date satisfies a threshold.

The document image may be requested and retrieved from an individual in a variety of ways. For example, the computing device may transmit, to the second computing device, a link to a webpage comprising a form, wherein the form comprises an e-mail input field and a file input field. Then the computing device may receive, via the webpage, an indication of the e-mail account and the document image.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure

FIG. 3 depicts a method comprising steps for processing images of printed documents transmitted by third parties to identify associations between those printed documents and database entries.

FIG. 4 depicts a database containing entries that indicate various individuals and anticipated document contents.

FIG. 5 depicts a letter from a third party.

FIG. 6 depicts a form for uploading a document image.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, it can be prohibitively difficult to correlate third party (e.g., governmental entity) communications with database entries because third parties cannot be reliably trusted to include consistent and/or correct information in those communications. For instance, the California State Controller's Office routinely sends letters regarding unclaimed property to Californian citizens; however, these letters unfortunately sometimes contain misspellings, misinformation, broad summarizations of amounts in issue (e.g., “About $50” instead of an exact value, such as “$51.33”), and the like. In turn, when Californian citizens then approach banks with such letters (e.g., with requests for the unclaimed property), it can be extremely difficult for banks to locate the correct record of the unclaimed property and confirm ownership of the property. Because such letters are generally form letters and are not under the control of those banks, it is generally not possible to add data (e.g., unique identifiers, barcodes, QR codes, or the like) to make the bank's correlation process easier. This problem, in extreme circumstances, might force an employee of the bank to manually search for such records, which can be extremely time-consuming.

To remedy these and other issues, aspects described herein relate to processing images of printed documents transmitted by third parties to identify associations between those printed documents and database entries. As a preliminary step, a computing device may store, in a database, records of individuals and data expected to be transmitted in letters to those customers. For example, in the context of unclaimed property, a record might identify a customer (e.g., John Smith), the actual amount of unclaimed property (e.g., $51.90), and the text expected to be seen in a letter to the customer as sent from a governmental entity (e.g., “Over $50 but under $100”, an abbreviation of the individual's name (“J. Smith”)). Then, the computing device may at some time later receive a document image. That document image might be an image of the letter, which might contain text such as a misspelling or misidentification of the customer's name (e.g., “Jon Smith”) and some other textual description of the unclaimed property (e.g., “Between $50 and $100”). The computing device may then be able to correlate the database record and the textual content of the image of the letter even when the names are different and even when the descriptions of the unclaimed property are different. After all, a fuzzy matching algorithm might determine that the differences between the text “John Smith” and “Jon Smith” and the text “Over $50 but under $100″ and ”Between $50 and $100″ are sufficiently small. In turn, this comparison process might allow the computing device to determine whether to automatically generate an electronic transmission of funds to an account associated with the individual that sent the image of the letter. Such a transmission might be conditioned on a trustworthiness of the individual, such as a trustworthiness of their e-mail account, of past call(s) made by the individual regarding the unclaimed property, or the like.

Aspects described herein improve the functioning of computers by using unique computing processes to correlate data (e.g., textual data in images of documents and different but similar data stored in a database) that would otherwise require the involvement of human beings. As indicated above, there are often circumstances where information in a document (e.g., a physical letter mailed to a Californian citizen) differs greatly from data stored in a database (e.g., customer data in a bank database). To remedy this issue, aspects described herein use a unique arrangement of computing processes and procedures to allow for the correlation of data that, previously, would have required human intervention. Stated differently, aspects described herein allow computers to perform steps that, previously, computers could not do without direct human involvement. With that said, the processes described herein are fundamentally rooted to the computing context (in no small part because the disclosure enables computers to do what they could not do before), and no arrangement of human beings could perform the processes described herein.

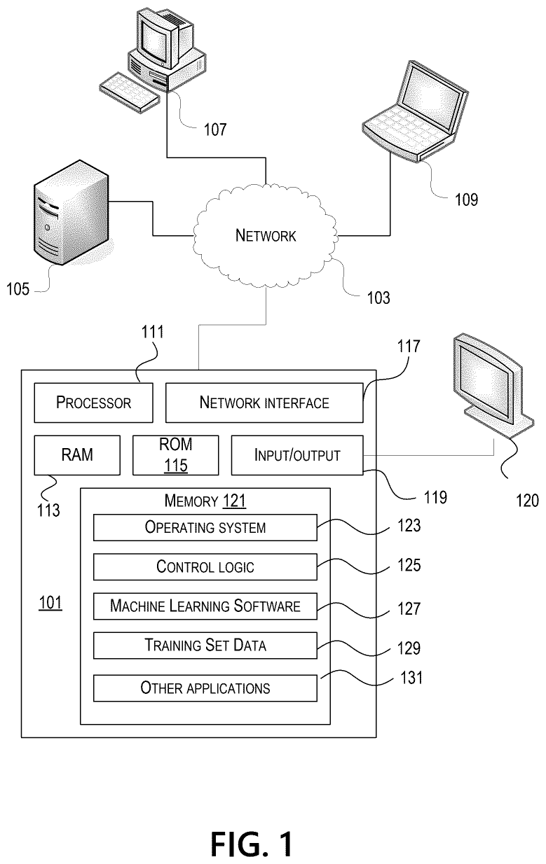

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, computing devices 101, 105, 107, 109, and others may operate in concert to provide parallel computing features in support of the operation of control logic 125 and/or machine learning software 127.

FIG. 1 also shows that the computing device 101 may comprise a Hardware Security Module (HSM) 132 and/or a Quantum Random Number Generator (QRNG) 133. The HSM 132 may comprise any computing module (e.g., one or more computer chips, attached cards, or the like) which may be capable of managing secrets, performing encryption and/or decryption, and/or otherwise performing security-and/or authentication-related functions. The HSM 132 may comprise, for instance, one or more secure cryptoprocessor chips which are capable of performing cryptographic operations. The QRNG 133 may comprise any computing module (e.g., one or more computer chips, attached cards, or the like) capable of generating a random number. Such a random number might be generated using quantum methods which permit the random number to have a high degree of entropy.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

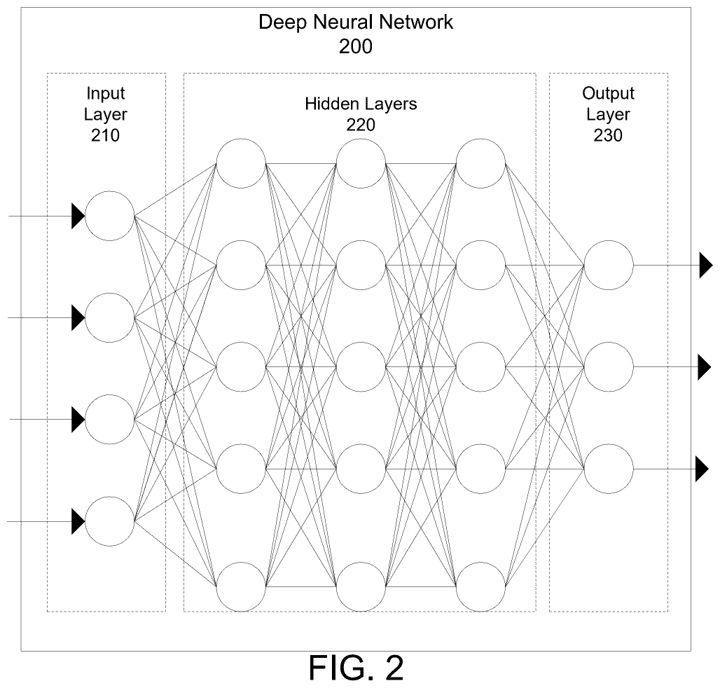

FIG. 2 illustrates an example of a deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

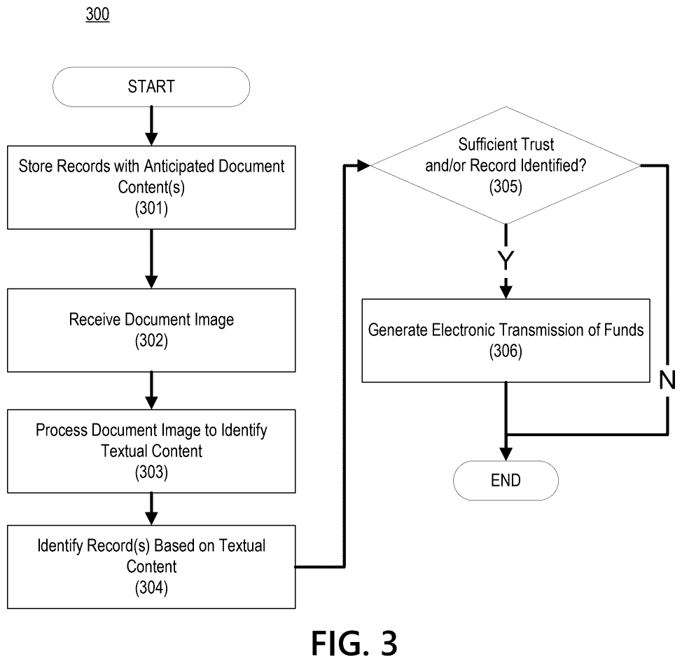

FIG. 3 depicts a method 300 comprising steps for processing images of printed documents transmitted by third parties to identify associations between those printed documents and database entries which may be performed by a computing device, such as any one of the devices described with respect to FIG. 1 and/or FIG. 2. The steps shown in FIG. 3 are illustrative, and may be re-arranged, omitted, and/or modified as desired. A computing device may comprise one or more processors and memory storing instructions that, when executed by the one or more processors, cause the performance of one or more of the steps depicted in FIG. 3. One or more non-transitory computer-readable media may store instructions that, when executed, cause the performance of one or more of the steps depicted in FIG. 3.

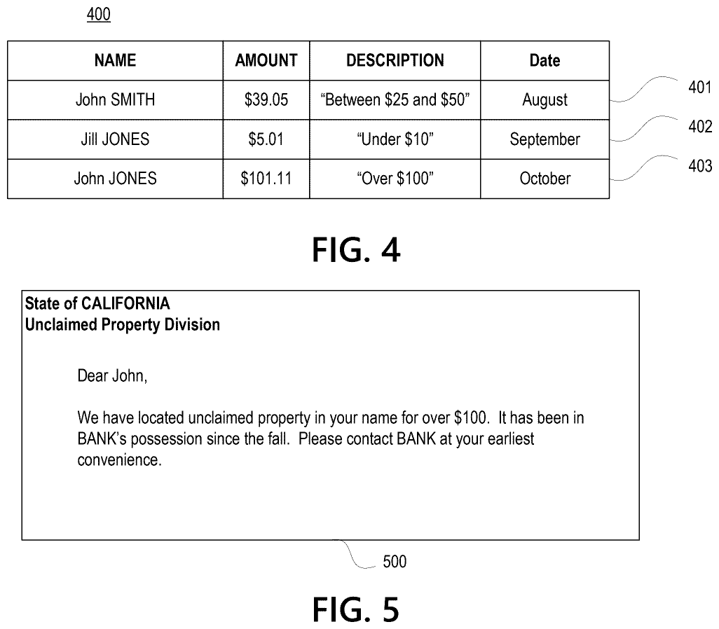

In step 301, a computing device may store records for individuals with anticipated document contents. This step may comprise anticipatorily storing information about various individuals (e.g., who might be associated with unclaimed property) as well as anticipated properties of letters that might be received by those individuals (e.g., letters from third parties, such as governmental entities, detailing the unclaimed property). For example, the computing device may store, in a database, a plurality of different records, wherein each record of the plurality of different records corresponds to a different individual and comprises one or more expected properties of a document to be received concerning the different individual. An example of such a database and illustrative records is provided in FIG. 4, which is discussed below.

To provide an example of step 301, as part of an unclaimed property process, an organization might generate a database full of records that indicate, among other information, the individuals owed unclaimed property and the identity (e.g., amount of currency of) unclaimed property. In addition to that information, the records may also store information indicating the expected properties of a document to be received by the corresponding individual relating to that unclaimed property. For example, if a third-party organization usually describes unclaimed property in terms of ranges (e.g., “Under $10,” “Between $10 and $50”), then that information might be stored in a record even when more specific data (e.g., an exact amount, such as $51.03) might be known. As another example, if a third-party organization routinely uses initials to refer to individuals rather than their full name (e.g., “J. S.” instead of “John Smith”), then those initials may be stored in the record as well. As yet another example, if the third-party organization routinely mischaracterizes or misspells certain terms (e.g., referring to real property as personal property or vice versa, misattributing real property in a certain county as belonging to a different county, or the like), then such information might be also stored in the record.

To determine the expected properties of a document to be received by the corresponding individual relating to that unclaimed property, the computing device may store data indicating, for a given third party, known characteristics of the third party's communications. Such characteristics might comprise, for example, a table of currency ranges (e.g., the idea that the third party describes currency using certain ranges), information about known misspellings or mischaracterizations, information about various policies used by the third party to generate letters, or the like. In some cases, the known characteristics of the third party's communications may be dictated by law or privacy considerations. For instance, in some instances, third parties might send letters omitting actual currency amounts so as to avoid disclosing such information via mail (which might be stolen).

Along those lines, to determine the expected properties of a document to be received by the corresponding individual relating to that unclaimed property, the computing device may process a history of letters transmitted by a third party. The computing device may process a history of different letters transmitted by the third party to determine commonalities, such as range(s) used by the third party to describe currencies, the propensity of the third party to misspell certain terms or misattribute aspects of real property, or the like. Such processing could also comprise identifying the likelihood that information is absent from a letter sent by a third party. For example, if—due to a printing error or the like—the address region of a letter is commonly smudged, then such information might only be partially readable in images of similar documents, and such information may be stored in a database record so that the potentially smudged nature of addresses is considered when performing document image processing.

Machine learning techniques may be used to process letters to identify commonalities and other features. For example, an unsupervised machine learning model (such as that described above with respect to FIG. 2) may be trained using a history of letters transmitted by a third party to determine categorizations of those letters, which might reveal certain expected properties of those letters going forward. For instance, real property-related letters might omit certain details (e.g., currency amounts) that personal property-related letters might contain. In turn, that trained machine learning model may be later used (e.g., as part of step 304, as will be described below) determine which group(s) a letter belongs to, which may aid in the fuzzy matching process.

In step 302, the computing device may receive a document image. This process may comprise receiving, from an individual, an image representing a letter that the individual received, from a third party, that relates to some unclaimed property. The individual might identify themselves in a variety of ways, such as via a username, password, e-mail account, or the like. For example, the computing device may receive, from a second computing device and via an e-mail account, a document image. That document image may be captured in a variety of ways, such as through a camera of a smartphone, via a scanner, or the like. An example of such a document image is provided in FIG. 5, which is discussed below.

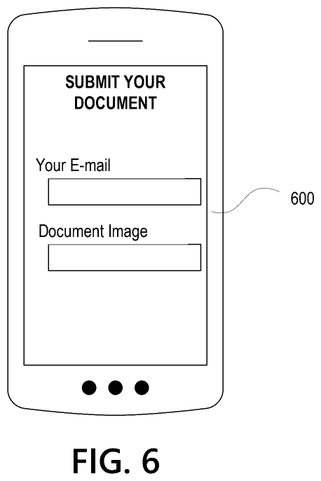

The computing device may receive the document image via a form, such as might be presented on a website, application, or the like. For example, the computing device may transmit, to the second computing device, a link to a webpage comprising a form, wherein the form comprises an e-mail input field and a file input field. Then, the computing device may receive, via the webpage, an indication of the e-mail account and/or the document image. An example of such a form is provided with respect to FIG. 6, which is discussed below.

In step 303, the computing device may process the received document image to identify textual content. This process may comprise processing the received document image using one or more algorithms to extract data from the document image. For example, the computing device may process, using an Optical Character Recognition (OCR) algorithm, the document image to identify textual content that comprises one or more of a quantity of currency, a date when a governmental entity transmitted a document corresponding to the document image, and/or a type of property.

While the disclosure herein uses certain data (e.g., a quantity of currency, a date when a governmental entity transmitted a document corresponding to the document image, and/or a type of property) as examples, a wide variety of textual content may be identified. For example, the received document image may be processed to identify a number of shares (e.g. of a stock), a reported owner name (e.g., who currently maintains some property, who is allegedly entitled to such property), a listing of additional owners, one or more account numbers, a date of last contact, or the like. In turn, the present disclosure is not limited to a particular type of data in such document images.

As part of processing the received document image, the computing device may identify one or more portions of data in processed document image that correspond to relevant textual content. Given that many document images may comprise information (e.g., letter headers, form language, unnecessary fluff) that might not be useful for the purposes of locating records in a database, it may be desirable to discard such information and focus on other data (e.g., quantities of currency, date(s), identifications of property, name(s), addresses) that are significantly more useful. This process might be performed in a variety of ways. For example, regular expressions or similar matching approaches may be used to identify, within the processed document image, portions of text corresponding to currency values (e.g., by looking for numeric values following a dollar sign). As another example, a natural language processing algorithm may be used to process data extracted from the document image to identify relevant and irrelevant portions of the data. As yet another example, historical processing of previous letters (as described above) may be used to identify form content (e.g., standard headers, welcome language, standard footers), and such form content may be removed from the data processed from the received document image.

In step 304, the computing device may identify one or more records in the database based on the textual content. This process may entail using fuzzy matching approaches to identify, based on the data extracted via processing from the received document image, one or more records that relate to the document image. For example, the computing device may query, using a fuzzy matching algorithm and based on comparing at least a portion of the textual content to the one or more expected properties, the plurality of different records stored in the database to identify a first record of the plurality of different records. The result of this process may be to correlate content from the document image, which may be unreliable, misspelled, or otherwise inaccurate, with record(s) in the database, even where the correlation might be imperfect.

As already suggested above, the textual content need not exactly match the records in the database. In some cases, the description of unclaimed property itself might be different. For instance, the first record may indicate a different quantity of currency, and the computing device may identify the first record by determining that a difference between the quantity of currency and the different quantity of currency satisfies a threshold. This may be particularly useful where a third-party government agency typically rounds currency values (e.g., “Around $50” instead of “$51.01”) or provides ranges of currency values (e.g., “From $10 to $20” instead of “$15.03”). This may also be useful where the government agency describes real property in a broad sense (e.g., “Real Property in Los Angeles”) rather than providing specificity as to the real property (e.g., a specific street address). Such fuzzy matching may equally apply to other data, such as names, dates, and the like. For example, the first record may indicate a different date when the governmental entity transmitted the document corresponding to the document image, and the computing device may identify the first record by determining that a difference between the date and the different date satisfies a threshold. As another example, the first record may indicate a different name (e.g., a legal name rather than a nickname), and the computing device may identify the first record by determining that a difference between names satisfies a threshold.

The identification of the one or more records may comprise use of machine learning techniques, such as use of the artificial neural network described with respect to FIG. 2. A machine learning model implemented via an artificial neural network may be trained to correlate letters with one or more records of a database. To be trained to perform this task, the artificial neural network may be trained using training data that comprises associations between document images (e.g., past letters of unclaimed property) and corresponding record entries (e.g., past unclaimed property records). This training process may advantageously leverage the history of manual human involvement (e.g., a history of bank employees having to manually locate records in the past) to train a machine learning model to perform similar tasks automatically. In turn, the trained machine learning model may be provided, as input (and, e.g., via an input node), all or portions of data from a document image (e.g., the textual content collected as part of step 303). Then, the trained machine learning model may provide, as output, an identification of one or more records in a database that correspond to the document image. Additionally and/or alternatively (e.g., where the trained machine learning model does not have direct access to the database), the trained machine learning model may output likely properties of the record in the database, which may be then used to query the database (e.g., using a fuzzy matching algorithm) to identify a sufficiently similar record.

In step 305, the computing device may determine whether there is sufficient trust to automatically transmit funds to an individual and/or whether a record corresponds to a document image. In the context of unclaimed property, such as unclaimed funds, there may be circumstances where a valid and trustworthy request for those unclaimed funds can be addressed automatically, especially when the amount of funds is somewhat low. For instance, if a properly-authenticated individual requests unclaimed funds in the amount of $4.01 and provides a proper letter to that effect from a government agency, and if a record is correctly identified corresponding to the letter, it may be financially prudent to automatically remit those funds to the individual, rather than to wait for human involvement in the process (which might be time-consuming and wasteful). In turn, the computing device may be capable of automatically generating an automatic transmission of a quantity of funds if a trustworthiness level satisfies a threshold and based on determining that a record corresponds to a document image. Such a decision may be based on authentication of the individual (e.g., using a username and password), a trustworthiness of an e-mail account associated with the user (e.g., if the document image was e-mailed from a property-vetted e-mail account), or the like. For example, the computing device may determine whether a trust level associated with an e-mail account satisfies a threshold.

The trust level may be based on domain(s) associated with e-mail accounts. In some cases, document images may be received from an e-mail account (e.g., from a particular e-mail address and via e-mail) and/or as associated with an e-mail account (e.g., via a web form that receives, among other things, an indication of an e-mail of the user). In turn, this e-mail may be used to identify a trustworthiness of the request. This trustworthiness may be based on whether the e-mail is known (e.g., if it is associated with a known individual in a database, such as a customer database), whether the e-mail is from a trustworthy e-mail address (e.g., a major company e-mail domain), or the like. For example, the computing device may determine the trust level associated with the e-mail account based on a domain of the e-mail account.

The trust level may be determined using machine learning techniques, such as through use of the artificial neural network(s) described above with respect to FIG. 2. A trained machine learning model may be generated by training an artificial neural network using training data comprising illustrative data (e.g., document images, e-mail addresses, times of day when documents are received) and corresponding trust values. In turn, the trained machine learning model may be trained to output trust values based on input data comprising similar data. As such, the trust level may be generated using such a machine learning model.

The trust level may be compared to a threshold based on the quantity of currency in question. It may be inadvisable to automatically transmit quantities of funds (e.g., amounts over one hundred dollars) without human involvement, even when a request looks entirely legitimate. That said, in the context of small quantities of currency and in the context of unclaimed property (where the likelihood of scams might be somewhat low given the complexity of the process to request return of the unclaimed property), the automatic return of such currency may be permissible because human involvement may be undesirably costly. As such, lower quantities of currency (e.g., a few dollars) might be associated with a relatively permissive threshold, whereas higher quantities of currency might be associated with a somewhat less permissive threshold. Moreover, non-currency unclaimed property (e.g., real property), due to its nature (and, potentially, the necessity of human involvement, such as lawyer involvement) might never be automatically transferred.

The decision in step 305 may be further based on a trust level of a telephone call. The transmission of the document image by a user (e.g., as part of receiving the document image in step 302) may be part of a process whereby the user calls an organization. For instance, a user might call a bank regarding their unclaimed property and, after the call, use an electronic form to submit an image of a letter they received from their state government detailing the unclaimed property. As such, details of (e.g., the trustworthiness of) the call may be used to determine whether there is sufficient trust to automatically transmit the funds to that user. For example, the computing device may identify a record of a telephone call associated with the first record, wherein the instructions. In such an example, the decision in step 305 may comprise determining whether a second trust level associated with the telephone call satisfies a threshold. The trust level associated with the telephone call may be based on an origin of the telephone call (e.g., whether it came from a known and/or trusted number or an unknown/untrusted number), using voice identification on the call (e.g., whether a voice print of the caller matched a known voice print), or the like.

In step 306, the computing device may automatically generate an electronic transmission of funds. In the case where the trust level discussed with respect to step 305 satisfies a threshold and based on determining that the first record corresponds to the document image, the computing device may take one or more steps to automatically transmit the funds to the correct recipient. For example, the computing device may automatically generate an electronic transmission of funds to an account associated with the first individual. This may comprise transmitting instructions to one or more other computing devices, such as payment processing platforms.

FIG. 4 depicts a database 400 containing entries that indicate various individuals and anticipated document contents. A first record 401 shows that “John SMITH” is owed $39.05, which might be described in a letter from a governmental entity as being “Between $25 and $50” and being owed since August. A second record 402 shows that “Jill JONES” is owed $5.01, which might be described in a letter from a governmental entity as being “Under $10” and being owed since September. A third record 403 shows that “John JONES” is owed $101.11, which might be described in a letter from a governmental entity as being “Over $100” and being owed since October.

FIG. 5 depicts a document image 500 from a third-party governmental agency. It indicates that “John” is owed “Over $100,” and that amount has been owed “since the fall.” In conjunction with FIG. 4, FIG. 5 illustrates why fuzzy matching (and the predictive entries in the database 400) may be necessary to correlate the document image 500 with one of the records in the database 400. In the example illustrated in FIG. 4 and FIG. 5, there are two “John” entries, both are owed funds in the fall (though there might be some debate over whether “August” falls in the fall under the third party's definitions of such, as the term might be intentionally vague), and the document image 500 does not mention an exact amount of the funds owed. That said, because the database 400 contains an entry (the third record 403) that anticipates the letter to contain the phrase “Over $100,” it might be safely concluded that the document image 500 correlates to the third record 403, and not the other records.

FIG. 6 depicts a form 600 for uploading a document image. As described with respect to step 302 of FIG. 3, as part of receiving a document image, a user might use a form (such as might be presented on a web interface, an application, or the like) to enter in their information, such as their e-mail address, a copy of the document image, and the like. Indeed, in some circumstances, the form might aid a user in capturing images of the document by, for instance, opening a camera application on the user's device and capturing one or more images of a document.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing device configured to process images of printed documents transmitted by third parties to identify associations between those printed documents and database entries, the computing device comprising:
one or more processors; and
memory storing instructions that, when executed by the one or more processors, cause the computing device to:
store, in a database, a plurality of different records, wherein each record of the plurality of different records corresponds to a different individual and comprises one or more expected properties of a document to be received concerning the different individual;
receive, from a second computing device and via an e-mail account, a document image;
process, using an Optical Character Recognition (OCR) algorithm, the document image to identify textual content that comprises one or more of:
a quantity of currency;
a date when a governmental entity transmitted a document corresponding to the document image; or
a type of property;
identify a first record, of the plurality of different records, corresponding to a first individual by:
providing, as input to a trained machine learning model, at least a portion of the textual content, wherein the trained machine learning model comprises an artificial neural network trained, using training data, to correlate textual content with one or more records of the database, and wherein the training data comprises associations between textual content from document images and corresponding records in the database; and
receiving, as output from the trained machine learning model, output comprising one or more predicted record properties; and
querying, using the one or more predicted record properties, the database to identify the first record;
determine a trust level associated with the e-mail account by querying a database storing associations between known users and e-mail accounts; and
based on determining that a the trust level associated with the e-mail account satisfies a threshold corresponding to the quantity of currency, and based on determining that the first record corresponds to the document image, automatically generate an electronic transmission of funds to an account associated with the first individual.

2. The computing device of claim 1, wherein the instructions, when executed by the one or more processors, cause the computing device to:
identify a record of a telephone call associated with the first record, wherein the instructions, when executed by the one or more processors, cause the computing device to automatically generate the electronic transmission of funds based on a second trust level associated with the telephone call.

3. The computing device of claim 1, wherein the instructions, when executed by the one or more processors, cause the computing device to:
determine the trust level associated with the e-mail account based on a domain of the e-mail account.

4. The computing device of claim 1, wherein the first record indicates a different quantity of currency, and wherein the instructions, when executed by the one or more processors, cause the computing device to identify the first record by determining that a difference between the quantity of currency and the different quantity of currency satisfies a threshold.

5. The computing device of claim 1, wherein the first record indicates a different date when the governmental entity transmitted the document corresponding to the document image, and wherein the instructions, when executed by the one or more processors, cause the computing device to identify the first record by determining that a difference between the date and the different date satisfies a threshold.

6. The computing device of claim 1, wherein the instructions, when executed by the one or more processors, cause the computing device to receive the document image by causing the computing device to:
transmit, to the second computing device, a link to a webpage comprising a form, wherein the form comprises an e-mail input field and a file input field; and
receive, via the webpage:
an indication of the e-mail account, and
the document image.

7. The computing device of claim 1, wherein the one or more expected properties comprises a description of a quantity of a currency.

8. A method for processing images of printed documents transmitted by third parties to identify associations between those printed documents and database entries, the method comprising:
storing, in a database, a plurality of different records, wherein each record of the plurality of different records corresponds to a different individual and comprises one or more expected properties of a document to be received concerning the different individual;
receiving, from a second computing device and via an e-mail account, a document image;
processing, using an Optical Character Recognition (OCR) algorithm, the document image to identify textual content that comprises one or more of:
a quantity of currency;
a date when a governmental entity transmitted a document corresponding to the document image; or
a type of property;
identifying a first record, of the plurality of different records, corresponding to a first individual by:
providing, as input to a trained machine learning model, at least a portion of the textual content, wherein the trained machine learning model comprises an artificial neural network trained, using training data, to correlate textual content with one or more records of the database, and wherein the training data comprises associations between textual content from document images and corresponding records in the database; and
receiving, as output from the trained machine learning model. output comprising one or more predicted record properties;
querying, using the one or more predicted record properties, the database to identify the first record;
determining a trust level associated with the e-mail account by querying a database storing associations between known users and e-mail accounts; and
based on determining that the trust level associated with the e-mail account satisfies a threshold corresponding to the quantity of currency and based on determining that the first record corresponds to the document image, automatically generating an electronic transmission of funds to an account associated with the first individual.

9. The method of claim 8, further comprising:
identifying a record of a telephone call associated with the first record, wherein the automatically generating the electronic transmission of funds is based on a second trust level associated with the telephone call.

10. The method of claim 8, further comprising:
determining the trust level associated with the e-mail account based on a domain of the e-mail account.

11. The method of claim 8, wherein the first record indicates a different quantity of currency, and wherein the identifying the first record comprises determining that a difference between the quantity of currency and the different quantity of currency satisfies a threshold.

12. The method of claim 8, wherein the first record indicates a different date when the governmental entity transmitted the document corresponding to the document image, and wherein identifying the first record comprises determining that a difference between the date and the different date satisfies a threshold.

13. The method of claim 8, further comprising:
transmitting, to the second computing device, a link to a webpage comprising a form, wherein the form comprises an e-mail input field and a file input field; and
receiving, via the webpage:
an indication of the e-mail account, and
the document image.

14. The method of claim 8, wherein the one or more expected properties comprises a description of a quantity of a currency.

15. One or more non-transitory computer-readable media storing instructions configured to process images of printed documents transmitted by third parties to identify associations between those printed documents and database entries, wherein the instructions, when executed by one or more processors of a computing device, cause the computing device to:
store, in a database, a plurality of different records, wherein each record of the plurality of different records corresponds to a different individual and comprises one or more expected properties of a document to be received concerning the different individual;
receive, from a second computing device and via an e-mail account, a document image;
process, using an Optical Character Recognition (OCR) algorithm, the document image to identify textual content that comprises one or more of:
a quantity of currency;
a date when a governmental entity transmitted a document corresponding to the document image; or
a type of property;
identify a first record, of the plurality of different records, corresponding to a first individual by:
providing, as input to a trained machine learning model, at least a portion of the textual content, wherein the trained machine learning model comprises an artificial neural network trained, using training data, to correlate textual content with one or more records of the database, and wherein the training data comprises associations between textual content from document images and corresponding records in the database: and
receiving, as output from the trained machine learning model, output comprising one or more predicted record properties; and
querying, using the one or more predicted record properties, the database to identify the first record;
determine a trust level associated with the e-mail account by querying a database storing associations between known users and e-mail accounts: and
based on determining that the trust level associated with the e-mail account satisfies a threshold corresponding to the quantity of currency and based on determining that the first record corresponds to the document image, automatically generate an electronic transmission of funds to an account associated with the first individual.

16. The one or more non-transitory computer-readable media of claim 15, wherein the instructions, when executed by the one or more processors, cause the computing device to:
identify a record of a telephone call associated with the first record, wherein the instructions, when executed by the one or more processors, cause the computing device to automatically generate the electronic transmission of funds based on a second trust level associated with the telephone call.

17. The one or more non-transitory computer-readable media of claim 15, wherein the instructions, when executed by the one or more processors, cause the computing device to:
determine the trust level associated with the e-mail account based on a domain of the e-mail account.

18. The one or more non-transitory computer-readable media of claim 15, wherein the first record indicates a different quantity of currency, and wherein the instructions, when executed by the one or more processors, cause the computing device to identify the first record by determining that a difference between the quantity of currency and the different quantity of currency satisfies a threshold.

19. The one or more non-transitory computer-readable media of claim 15, wherein the first record indicates a different date when the governmental entity transmitted the document corresponding to the document image, and wherein the instructions, when executed by the one or more processors, cause the computing device to identify the first record by determining that a difference between the date and the different date satisfies a threshold.

20. The one or more non-transitory computer-readable media of claim 15, wherein the instructions, when executed by the one or more processors, cause the computing device to receive the document image by causing the computing device to:
transmit, to the second computing device, a link to a webpage comprising a form, wherein the form comprises an e-mail input field and a file input field; and
receive, via the webpage:
an indication of the e-mail account, and
the document image.
